(19) United States
(12) Patent Application Publication
(10) Pub. No.: US 2026/0110196 A1
(43) Pub. Date: Apr. 23, 2026

(54) VEHICLE LATCH WITH SECONDARY CLAW SUPPORT AND METHOD FOR SUPPORTING CLAW OF A VEHICLE LATCH

(71) Applicant: Inteva Products, LLC, Troy, MI (US)

(72) Inventors: Gustavo Gonzalez Flores, Ciudad Juarez (MX); Carlos Tostado, Ciudad Juarez (MX); Donald Michael Perkins, Rochester Hills, MI (US)

(21) Appl. No.: 19/364,451

(22) Filed: Oct. 21, 2025

Related U.S. Application Data
(60) Provisional application No. 63/709,842, filed on Oct. 21, 2024.

(51) Int. Cl. E05B 77/10

(52) U.S. Cl. CPC E05B 77/10

(57) ABSTRACT

A retention module for receiving and engaging a striker, including: a frame, the frame having a secondary support feature; a claw pivotally mounted to the frame via a claw pivot; a pawl pivotally mounted to the frame via a pawl pivot; and wherein the secondary support feature makes contact with the claw when the claw is moved in a direction transverse to an axis of the claw pivot.

### CROSS REFERENCE TO RELATED APPLICATIONS

The present application claims the benefit of U.S. Provisional Patent Application 63/709,842 filed on Oct. 21, 2024, the entire contents of which are incorporated herein by reference thereto.

### BACKGROUND

Exemplary embodiments of the present disclosure pertain to the art of vehicle latches.

In some situations, a vehicle latch in a latched stated is subjected to external forces. As such, it is desirable to provide a vehicle latch that able to withstand external forces.

### BRIEF DESCRIPTION

Disclosed is a retention module for receiving and engaging a striker, including: a frame, the frame having a secondary support feature; a claw pivotally mounted to the frame via a claw pivot; a pawl pivotally mounted to the frame via a pawl pivot; and wherein the secondary support feature makes contact with the claw when the claw is moved in a direction transverse to an axis of the claw pivot.

In addition to one or more of the features described above, or as an alternative to any of the foregoing embodiments, the retention module further includes a backplate, the claw pivot and the pawl pivot are secured to the frame and the backplate and extend therebetween and the claw and the pawl pivot between the frame and the backplate.

In addition to one or more of the features described above, or as an alternative to any of the foregoing embodiments, the secondary support feature is integrally formed with the frame such that the secondary support feature and the frame are from a single component.

In addition to one or more of the features described above, or as an alternative to any of the foregoing embodiments, the secondary support feature is formed by a stamping process applied to the frame or an extrusion process applied to the frame.

In addition to one or more of the features described above, or as an alternative to any of the foregoing embodiments, the secondary support feature has a shape similar to ½ of a hemisphere.

In addition to one or more of the features described above, or as an alternative to any of the foregoing embodiments, the secondary support feature is formed by a protruding portion of the frame that is stamped from the frame.

In addition to one or more of the features described above, or as an alternative to any of the foregoing embodiments, the protruding portion of the secondary support feature has an open end facing a portion of the claw that contacts the secondary support feature when the claw has moved in the direction transverse to the axis of the claw pivot.

In addition to one or more of the features described above, or as an alternative to any of the foregoing embodiments, the secondary support feature has a contact surface for contacting the claw when the claw has moved in the direction transverse to the axis of the claw pivot.

In addition to one or more of the features described above, or as an alternative to any of the foregoing embodiments, the secondary support feature is stamped from the frame and the secondary support feature extends upwardly from the frame and an opening is provided in the frame due to formation of the secondary support feature.

In addition to one or more of the features described above, or as an alternative to any of the foregoing embodiments, the secondary support feature is separately secured to the frame.

Also disclosed is a vehicle latch, including: a retention module for receiving and engaging a striker, the retention module including: a frame, the frame having a secondary support feature; a claw pivotally mounted to the frame via a claw pivot; a pawl pivotally mounted to the frame via a pawl pivot; and wherein the secondary support feature makes contact with the claw when the claw is moved in a direction transverse to an axis of the claw pivot.

In addition to one or more of the features described above, or as an alternative to any of the foregoing embodiments, the vehicle latch further includes a backplate, the claw pivot and the pawl pivot are secured to the frame and the backplate and extend therebetween and the claw and the pawl pivot between the frame and the backplate.

In addition to one or more of the features described above, or as an alternative to any of the foregoing embodiments, the secondary support feature is integrally formed with the frame such that the secondary support feature and the frame are from a single component.

In addition to one or more of the features described above, or as an alternative to any of the foregoing embodiments, the secondary support feature is formed by a stamping process applied to the frame or an extrusion process applied to the frame.

In addition to one or more of the features described above, or as an alternative to any of the foregoing embodiments, the secondary support feature has a shape similar to ½ of a hemisphere.

In addition to one or more of the features described above, or as an alternative to any of the foregoing embodiments, the secondary support feature is formed by a protruding portion of the frame that is stamped from the frame.

In addition to one or more of the features described above, or as an alternative to any of the foregoing embodiments, the protruding portion of the secondary support feature has an open end facing a portion of the claw that contacts the secondary support feature when the claw has moved in the direction transverse to the axis of the claw pivot.

In addition to one or more of the features described above, or as an alternative to any of the foregoing embodiments, the secondary support feature has a contact surface for contacting the claw when the claw has moved in the direction transverse to the axis of the claw pivot.

In addition to one or more of the features described above, or as an alternative to any of the foregoing embodiments, the secondary support feature is stamped from the frame and the secondary support feature extends upwardly from the frame and an opening is provided in the frame due to formation of the secondary support feature.

Also disclosed is a method for transferring forces applied to a claw of a retention module to a frame of the retention module, including: pivotally mounting a claw to a frame of the retention module via a claw pivot; contacting a secondary support feature of the frame with the claw when the claw is moved in a direction transverse to an axis of the claw pivot.

### BRIEF DESCRIPTION OF THE DRAWINGS

FIG. 1 is a perspective view of a vehicle latch or vehicle latch assembly with a retention module in accordance with the present disclosure;

FIG. 2 is a view of a retention module and a striker;

FIG. 3 is a view along lines 3-3 of FIG. 2;

FIG. 4 is a perspective view of a retention module and a striker;

FIG. 5 is a perspective view of a retention module and a striker in a latched or primary position;

FIG. 6 is a view of a retention module and a striker in a latched or primary position;

FIG. 7 is a view along lines 7-7 of FIG. 6;

FIG. 8 is a perspective view of a retention module and a striker illustrating loads applied to the retention module and striker;

FIG. 9A is a top perspective view of a frame of a retention module in accordance with the present disclosure;

FIG. 9B is a bottom perspective view of a frame of a retention module in accordance with the present disclosure;

FIG. 10 is a top view of a frame of a retention module in accordance with the present disclosure;

FIG. 11 is a top perspective view of a frame of a retention module in accordance with the present disclosure;

FIGS. 12A and 12B illustrate operation of a retention module in accordance with the present disclosure;

FIG. 13 illustrates movement of a claw of a retention module without a secondary support feature;

FIG. 14 illustrates movement of a claim of a retention module with a secondary support feature in accordance with the present disclosure;

FIGS. 15A and 15B illustrate operation of a retention module in accordance with the present disclosure;

FIG. 16A is a view along lines 16A-16A of FIG. 15A;

FIGS. 17A and 17B illustrate operation of a retention module in accordance with another embodiment of the present disclosure;

FIG. 18A is a view along lines 18A-18A of FIG. 17A;

FIG. 19A is a bottom view of a frame of a retention module in accordance with the present disclosure;

FIG. 19B is a top view of a frame of a retention module in accordance with the present disclosure;

FIG. 19C is a top perspective view of a frame of a retention module in accordance with the present disclosure;

FIG. 20A is a bottom view of a frame of a retention module in accordance with the present disclosure;

FIG. 20B is a top perspective view of a frame of a retention module in accordance with the present disclosure; and

FIG. 20C is a top perspective view of a frame of a retention module in accordance with the present disclosure.

### DETAILED DESCRIPTION

A detailed description of one or more embodiments of the disclosed apparatus and method are presented herein by way of exemplification and not limitation with reference to the attached Figures.

In accordance with the present disclosure, a retention module of a vehicle latch is provided with a secondary support that counteracts excessive loads applied to a claw of the retention module.

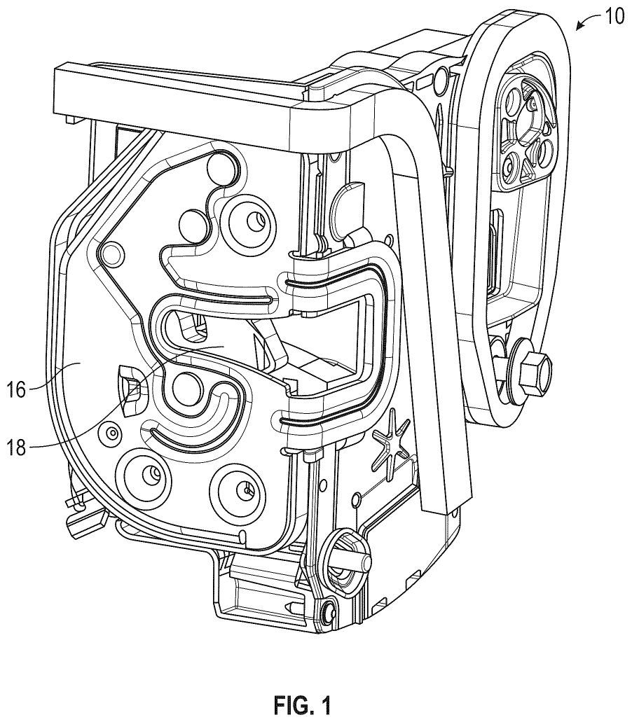

FIG. 1 is a perspective view of a vehicle latch or vehicle latch assembly 10 in accordance with the present disclosure.

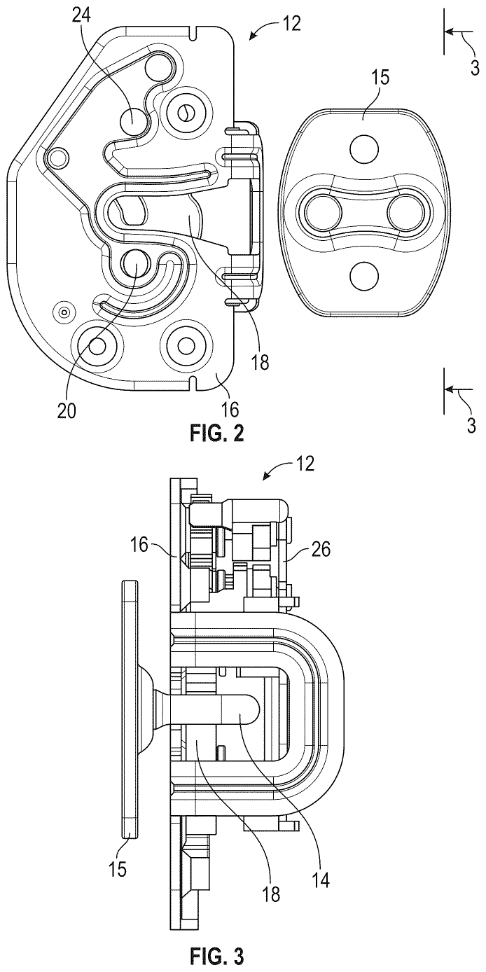

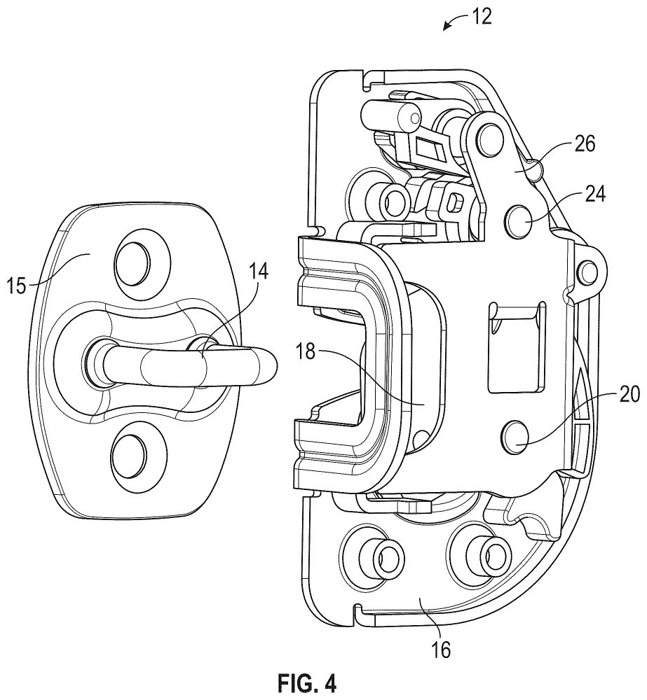

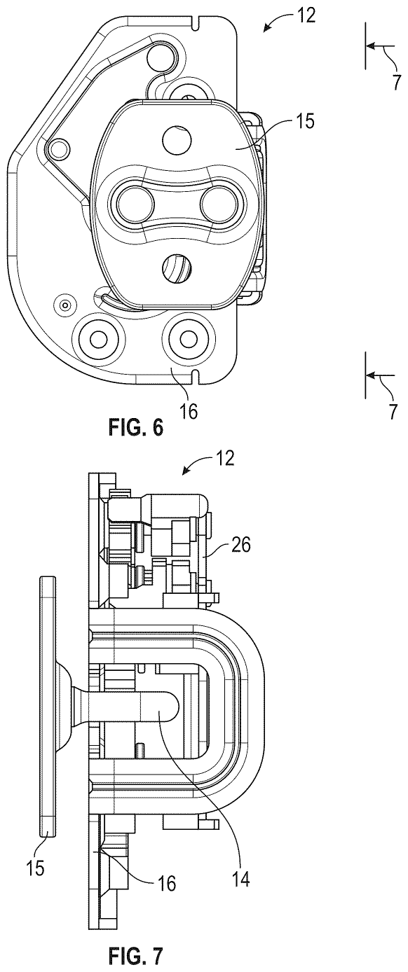

Referring now to at least FIGS. 2-8, the vehicle latch or vehicle latch assembly 10 includes a retention module 12 that is configured to received engage and release a striker 14. In one non-limiting embodiment, the striker 14 is secured to a striker plate 15. The striker plate 15 having openings for screws or fasteners to secure the striker plate 15 and striker 14 to a structure of a vehicle the vehicle latch or vehicle latch assembly 10 is secured to. In one implementation the vehicle latch or vehicle latch assembly 10 with the retention module 12 is secured to a movable structure of a vehicle such as a door and the striker is secured to a stationary structure such as a door frame or pillar. Alternatively, the vehicle latch or vehicle latch assembly 10 with the retention module 12 is secured to the stationary structure such as a door frame or pillar and the striker is secured to the movable structure of the vehicle such as a door.

The retention module 12 has a frame 16, a claw 18 pivotally mounted to the frame 16 via a claw pivot 20, a pawl 22 pivotally mounted to the frame 16 via a pawl pivot 24. The claw 18 is movable between at least the following positions, a primary or latched position wherein the claw 18 retains the striker 14 within the retention module 12, an open or unlatched position wherein the claw 18 releases the striker 14 from the retention module 12, and a secondary position between the primary or latched position and the open or unlatched position wherein the claw 18 still retains the striker 14 within the retention module 12 however, the claw 18 has rotated towards the open position.

The pawl 22 is movable between at least the following positions, an engaged position wherein the pawl 22 retains the claw 18 is the primary or latched position of the secondary position and a disengaged position wherein the pawl 22 allows the claw 18 to rotate towards the open position.

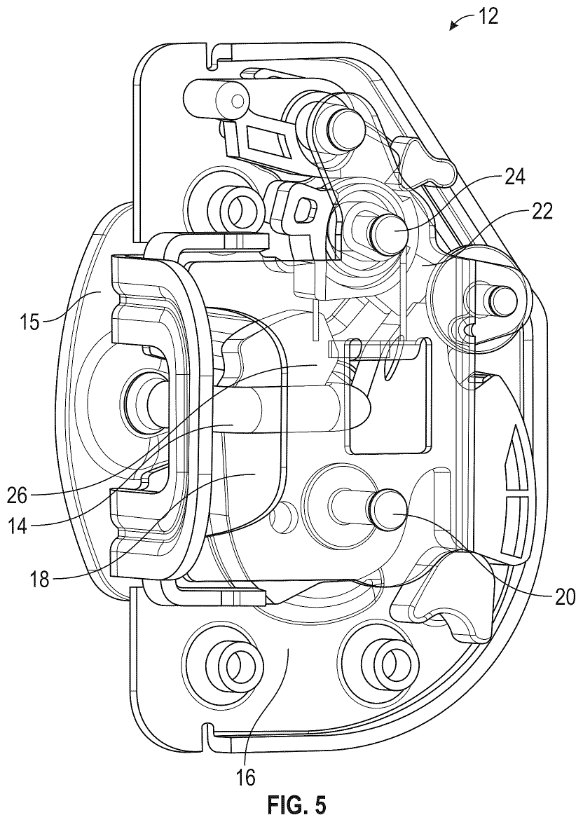

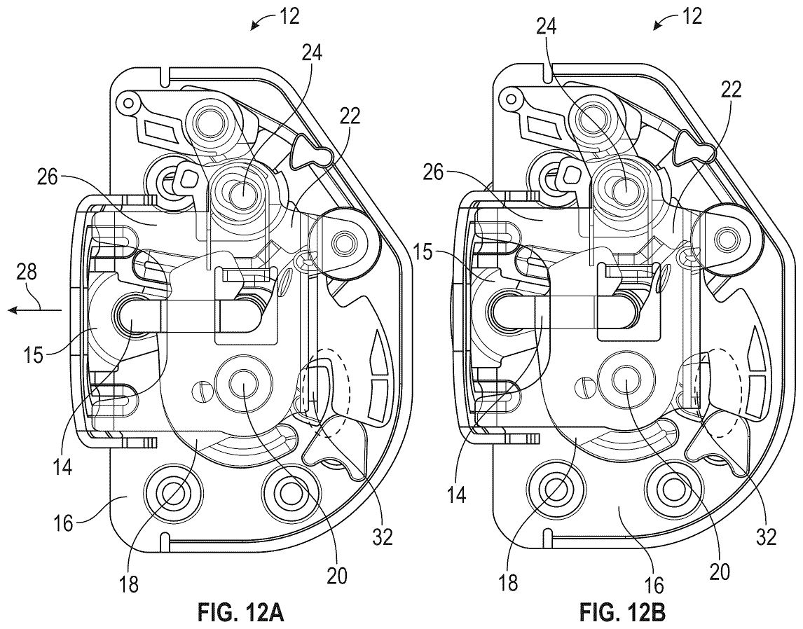

The retention module 12 also has an upper frame or backplate 26, the claw pivot 20 and the pawl pivot 24 are secured to the frame 16 and the upper frame or backplate 26 and extend therebetween. The claw 18 is pivotally mounted to the claw pivot 20 and the pawl 22 is pivotally mounted to the pawl pivot 24 such that the claw 18 and the pawl 22 pivot or rotated between the frame 16 and the upper frame or backplate 26. In at least FIGS. 5, 8, 9A, 12A and 12B, the upper frame or backplate 26 is shown in phantom.

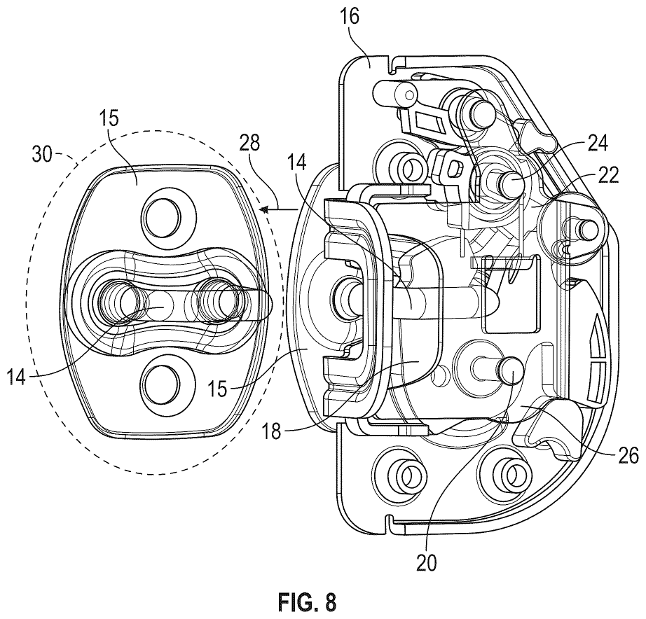

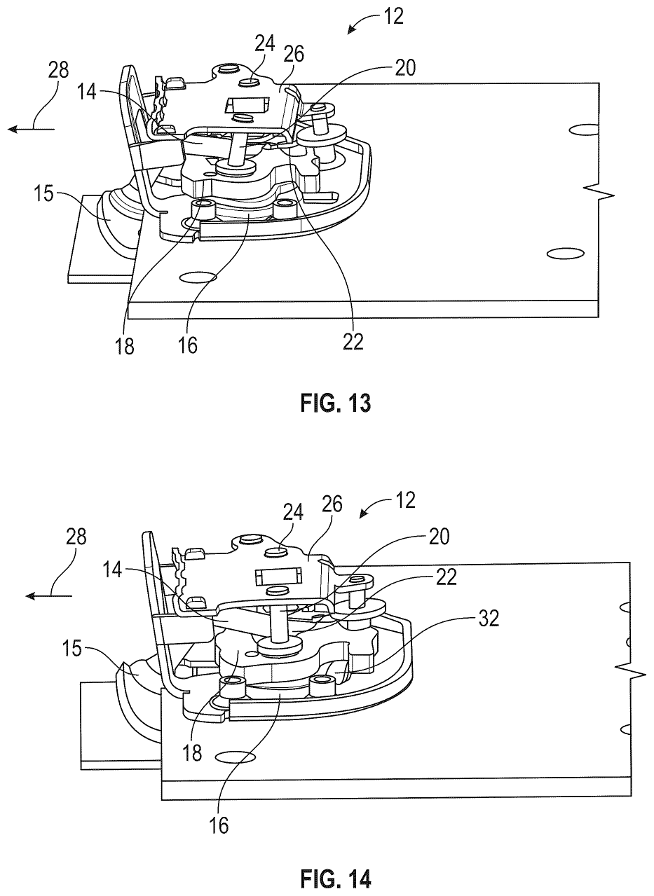

Referring now to at least FIG. 8, when the retention module 12 retains the striker 14 when the claw 18 is in the primary position and a force is applied to the claw 18 in the direction of at least arrow 28 toward a position 30 illustrated by the dashed lines in FIG. 8, the force is applied to the claw pivot 20. Initially, this force in the direction of arrow 28 will cause the frame 16 to deform and the claw 18 will move in the direction of arrow 28 and if the force in the direction of arrow 28 is greater than the tensile strength of the claw pivot 20, the claw pivot 20 will fail. As illustrated, the direction of arrow 28 is transverse to an axis of the claw pivot 20 or in other words the direction of arrow 28 is transverse to an axis of rotation of the claw 18 about the claw pivot 20. This failure is shown in at least FIG. 13. The failure of the claw pivot 20 is undesirable. In some situations, the force in the direction of arrow 28 may be due to the vehicle in which the latch 10 is secured is in an accident and the door to which the latch 10 is secured to has been deformed and/or the portion of the vehicle the striker 14 is secured to is deformed.

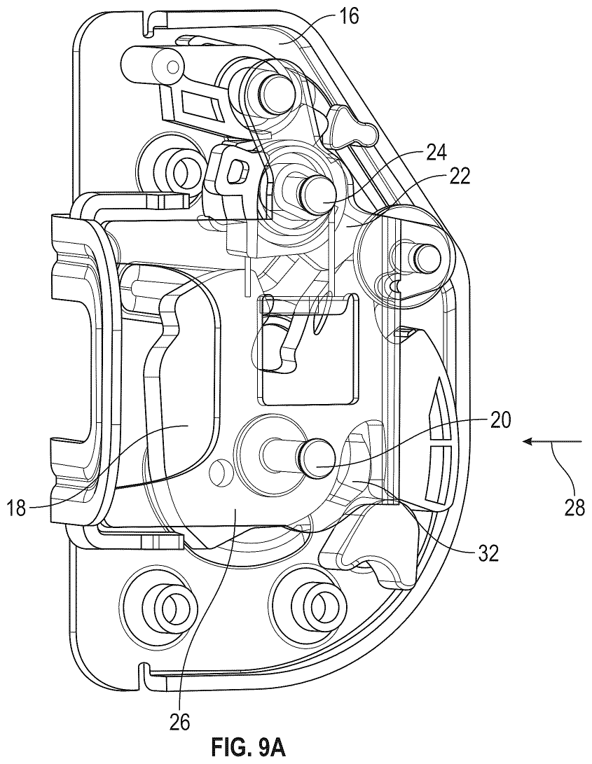

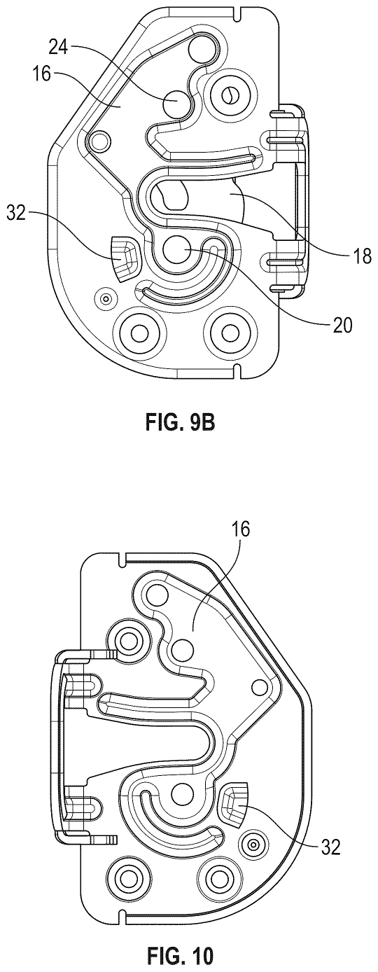

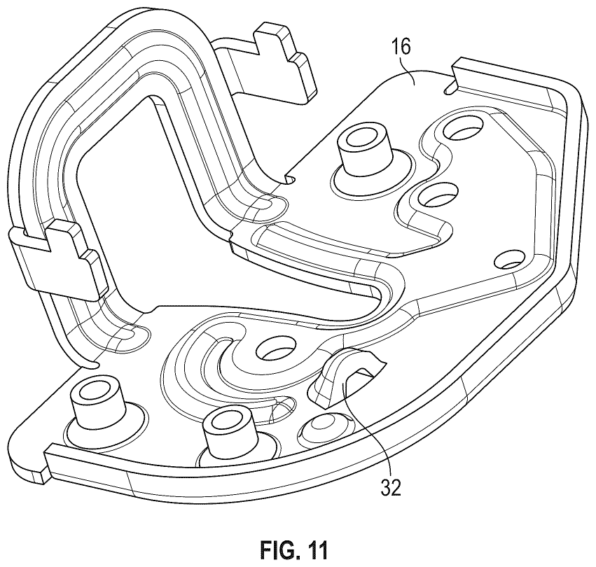

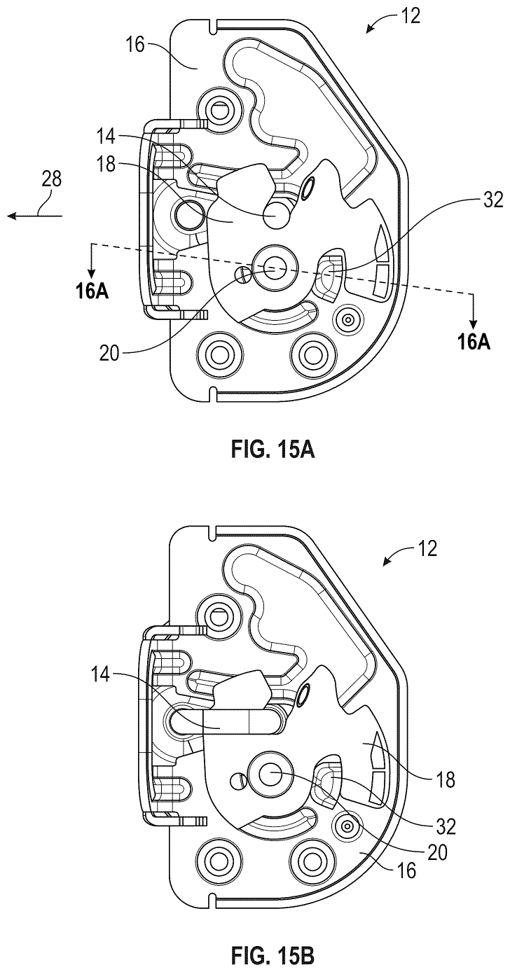

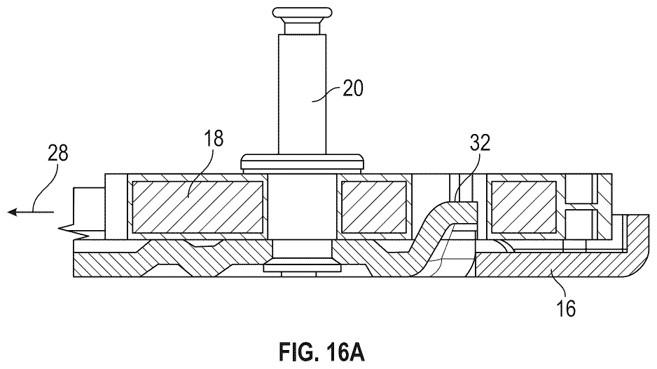

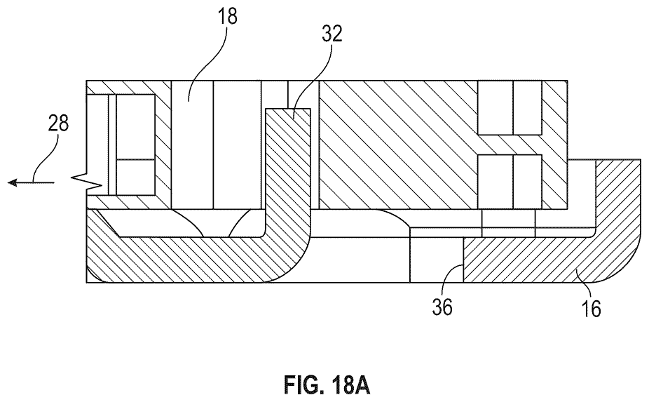

Referring now to at least FIGS. 9A-12B, 14 and 15A-18A, the frame 16 is provided with a secondary support feature 32, which is configured to contact a portion of the claw 18 when the claw is in the primary or latched position and the striker 14 and the retention module 12 are subjected to forces in the direction of arrow 28 as described above. Once this occurs and the frame 16 deforms to allow for movement of the claw 18 in the direction of arrow 28, the claw 18 will contact the secondary support feature 32, which will divert some of the forces in the direction of arrow 28 away from the claw pivot 20 to the frame 16. The inclusion of the secondary support feature 32 will allow the retention module 12 to be able to withstand higher forces in the direction of arrow 28 than a retention module 12 without a secondary support feature 32.

In other words and during normal operation of the retention module 12 (e.g., non-deformation of the retention module 12 and no movement of the claw 18 and claw pivot 20 in the direction of arrow 28) the claw 18 will not make contact with the second support feature 32.

In one non-limiting embodiment, the secondary support feature 32 is integrally formed with the frame 16 such that the secondary support feature 32 and the frame 16 are from a single component. In one non-limiting embodiment, the secondary support feature 32 is formed by a stamping process applied to the frame 16. In one configuration and as illustrated in at least FIGS. 9A-12B and 14-16A, the secondary support feature 32 has a shape similar to ½ of a hemisphere. As such, the secondary support feature 32 is formed by a protruding portion of the frame 16 that is stamped from the frame 16. The protruding portion of the secondary support feature 32 will have an open end facing the portion of the claw 18 that contacts the secondary support feature 32 when the claw 18 has moved in the direction of arrow 28 due to the deflection of the frame 16 and/or claw pivot 20. The end portions of the secondary support feature 32 will provide a contact surface 34 for contacting the claw 18 when it is moved in the direction of arrow 28 due to the forces applied in the direction of arrow 28. This contact will cause some of the forces to be applied to the frame 16 as opposed to the claw pivot 20.

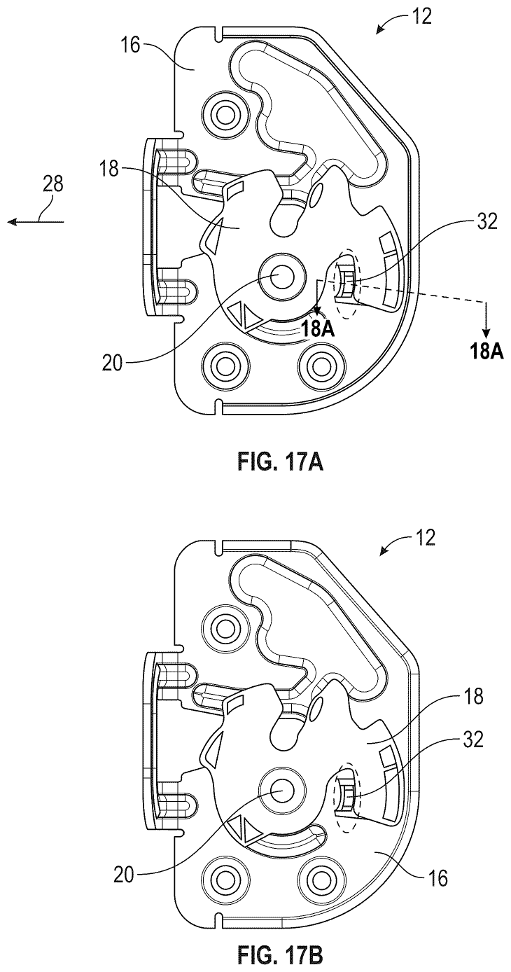

Referring now to at least FIGS. 17A and 17B, an alternative configuration of the secondary support feature 32. Here, the secondary support feature 32 is stamped or punched from the frame 16 and the secondary support feature 32 extends upwardly from the frame 16 and an opening 36 is provided in the frame 16 due to the formation of the secondary support feature 32 and the opening 36 is located before the contact surface of the secondary support feature 32.

In yet another embodiment, the secondary support feature 32 may be separately secured to the frame 16 and/or upper frame or backplate 26. For example, an addition pin, rod or pivot may be secured to and extend between the frame 16 and the upper frame or backplate 26. Alternatively, the secondary support feature may be a structural feature that can be secured with the frame using a fastener such as a screw. In yet another embodiment, the secondary support feature 32 may be any equivalent structural element that interacts with a portion of the claw 18 when it is moved in the direction of arrow 28.

At least FIGS. 9A, 12A, 15A, 16A, 17A, and 18A illustrate the claw 18 in the primary position without a load in the direction of arrow 28 such that there is a gap between the claw 18 and the secondary support feature 32, while at least FIGS. 9B, 12B, 15B and 17B illustrate the claw 18 in the primary position wherein a load in the direction of arrow 28 has been applied and the claw 18 has moved to be in contact with the secondary support feature 32. As mentioned above, the secondary support feature 32 prevents some of the load in the direction of arrow 28 from being applied to the claw pivot 20, which in turn allows the retention module 12 to be able to withstand higher forces than a retention module 12 without a secondary support feature 32.

In accordance with one non-limiting embodiment, the secondary support feature 32 is only configured to contact the claw 18 when the claw 18 is in the primary position and the claw 18 has moved in the direction of arrow 28 due to a force in the direction of arrow 28. For example, the secondary support feature 32 may be configured to be received within an area 38 defined by the claw 18.

Alternatively and in another embodiment, the secondary support feature 32 may be configured to contact the claw 18 when the claw 18 is in either the primary position or the secondary position and the claw 18 has moved in the direction of arrow 28 due to a force in the direction of arrow 28.

As such and in accordance with various embodiments of the present disclosure, and when the retention module 12 of a latch is engaged with the striker 14 in the primary position and a force is applied in a transversal direction (e.g., arrow 28), the claw pivot 20 tends to deform and drag the frame 16 which may cause failure of the retention module 12 at certain loads unless the retention module 12 is provided with the secondary support feature 32 as disclosed herein.

As such and in accordance with various embodiments of the present disclosure, current retention modules 12 of latch retention systems can be modified allowing a secondary support feature to be engaged after a predetermined amount of deformation, increasing the strength, and overall crash energy absorption of the retention module 12. In one non-limiting embodiment the predetermined amount of deformation may be 0.5 mm. Of course and in other embodiments, the predetermined amount of deformation may be greater or less than 0.5 mm.

As mentioned above, the secondary support feature 32 only assists in supporting the claw 18 when excessive forces are applied to the claw 18, claw pivot 20 and the frame 16. As such and during these events (excessive forces) the secondary support feature 32 can break inertia applied to the claw 18 and help in distribute energy in an additional area of the frame 16, and increase transversal strength in the latch the retention module 12 is located in.

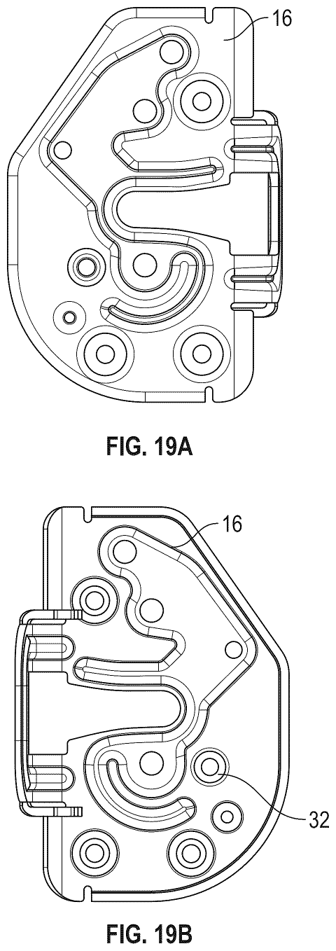

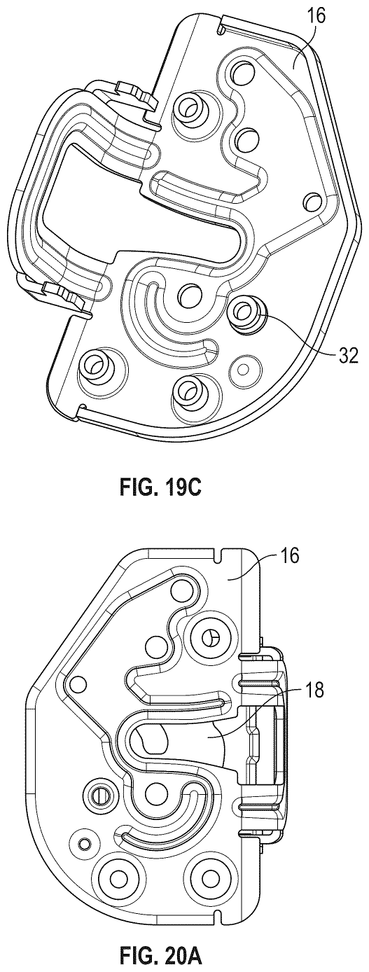

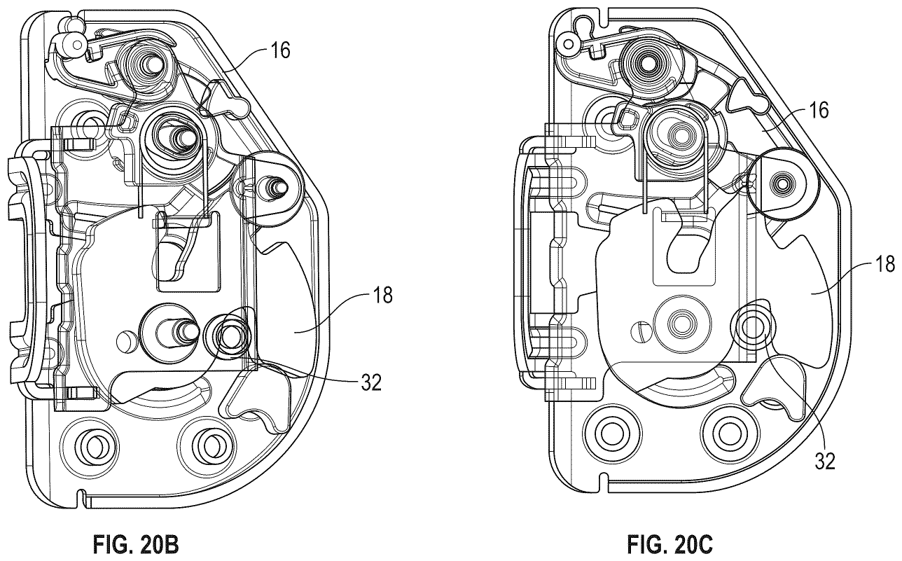

Referring now to at least FIGS. 19A-20C and in accordance with the present disclosure, the secondary support feature 32 is extruded from the material of the frame 16 such that the secondary support feature 32 and the frame 16 are from a single component. Here, the secondary support feature 32 may have a cylindrical or boss configuration that extends upwardly away from the frame 16 and in one non-limiting embodiment, the cylindrical or boss configuration of the secondary support feature 32 has a centrally located opening that extends through the secondary support feature 32 and the frame 16.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A retention module for receiving and engaging a striker, comprising:
a frame, the frame having a secondary support feature;
a claw pivotally mounted to the frame via a claw pivot;
a pawl pivotally mounted to the frame via a pawl pivot; and
wherein the secondary support feature makes contact with the claw when the claw is moved in a direction transverse to an axis of the claw pivot.

2. The retention module as in claim 1, further comprising a backplate, the claw pivot and the pawl pivot are secured to the frame and the backplate and extend therebetween and the claw and the pawl pivot between the frame and the backplate.

3. The retention module as in claim 1, wherein the secondary support feature is integrally formed with the frame such that the secondary support feature and the frame are from a single component.

4. The retention module as in claim 3, wherein the secondary support feature is formed by a stamping process applied to the frame or an extrusion process applied to the frame.

5. The retention module as in claim 4, wherein the secondary support feature has a shape similar to ½ of a hemisphere.

6. The retention module as in claim 1, wherein the secondary support feature is formed by a protruding portion of the frame that is stamped from the frame.

7. The retention module as in claim 6, wherein the protruding portion of the secondary support feature has an open end facing a portion of the claw that contacts the secondary support feature when the claw has moved in the direction transverse to the axis of the claw pivot.

8. The retention module as in claim 1, wherein the secondary support feature has a contact surface for contacting the claw when the claw has moved in the direction transverse to the axis of the claw pivot.

9. The retention module as in claim 1, wherein the secondary support feature is stamped from the frame and the secondary support feature extends upwardly from the frame and an opening is provided in the frame due to formation of the secondary support feature.

10. The retention module as in claim 1, wherein the secondary support feature is separately secured to the frame.

11. A vehicle latch, comprising:
a retention module for receiving and engaging a striker, the retention module comprising:
a frame, the frame having a secondary support feature;
a claw pivotally mounted to the frame via a claw pivot;
a pawl pivotally mounted to the frame via a pawl pivot; and
wherein the secondary support feature makes contact with the claw when the claw is moved in a direction transverse to an axis of the claw pivot.

12. The vehicle latch as in claim 11, further comprising a backplate, the claw pivot and the pawl pivot are secured to the frame and the backplate and extend therebetween and the claw and the pawl pivot between the frame and the backplate.

13. The vehicle latch as in claim 11, wherein the secondary support feature is integrally formed with the frame such that the secondary support feature and the frame are from a single component.

14. The vehicle latch as in claim 13, wherein the secondary support feature is formed by a stamping process applied to the frame or an extrusion process applied to the frame.

15. The vehicle latch as in claim 14, wherein the secondary support feature has a shape similar to ½ of a hemisphere.

16. The vehicle latch as in claim 11, wherein the secondary support feature is formed by a protruding portion of the frame that is stamped from the frame.

17. The vehicle latch as in claim 16, wherein the protruding portion of the secondary support feature has an open end facing a portion of the claw that contacts the secondary support feature when the claw has moved in the direction transverse to the axis of the claw pivot.

18. The vehicle latch as in claim 11, wherein the secondary support feature has a contact surface for contacting the claw when the claw has moved in the direction transverse to the axis of the claw pivot.

19. The vehicle latch as in claim 11, wherein the secondary support feature is stamped from the frame and the secondary support feature extends upwardly from the frame and an opening is provided in the frame due to formation of the secondary support feature.

20. A method for transferring forces applied to a claw of a retention module to a frame of the retention module, comprising:
pivotally mounting a claw to a frame of the retention module via a claw pivot;
contacting a secondary support feature of the frame with the claw when the claw is moved in a direction transverse to an axis of the claw pivot.
